(19) United States
(12) Patent Application Publication
(10) Pub. No.: US 2003/0058522 A1
(43) Pub. Date: Mar. 27, 2003

(54) Raman optical converters

(76) Inventors: Andrew V. Maroney, Epping (GB); Vincent Handerek, Grays (GB)

Correspondence Address: William M. Lee, Jr., Lee, Mann, Smith, McWilliamss, Sweeney & Ohlson, Suite 410, 209 South LaSalle Street, Chicago, IL, 60604-1202, US

(21) Appl. No.: 09/957,842

(22) Filed: Sep. 21, 2001

(51) Int. Cl. G02F 1/365; G02B 6/16

(52) U.S. Cl. 359/332; 385/122

(57) ABSTRACT

An optical converter 1 has a light source 2 producing light of one wavelength and an optical fibre 4 in which light from the source 2 is converted by Raman scattering from the one wavelength to another wavelength. The light of the another wavelength is output from the fibre 4. The fibre 4 is doped with deuterium which has a relatively long Stoke's shift such that the minimum number of shifts are involved in the conversion from the one wavelength to the another wavelength. The doping is achieved by saturating the fibre 4 with deuterium which is fixed by exposure to UV light.

### TECHNICAL FIELD

The invention relates to optical converters, in particular Raman optical converters which utilise the Raman effect to convert optical signals from one wavelength to another, and to methods of converting optical signals from one wavelength to another.

### BACKGROUND OF THE INVENTION

Raman scattering is a phenomenon which occurs in crystalline materials when incident light interacts with the vibrations of atoms in the crystal lattice. In essence, the atoms in the crystal lattice absorb the incident photons and re-emit photons with energy equal to the energy of the original photons plus or minus the energy of a vibration characteristic of the atom. As a result, the light is scattered and its wavelength is shifted.

Raman scattering may be positively utilised in optical communications systems typically comprising optical fibres carrying modulated optical signals. For example, in Raman fibre amplifiers, pump light, of a wavelength different to the light input for amplification, may be fed into an optical fibre to excite vibrational modes in the atoms of the fibre. The input light stimulates the vibrational modes to emit photons at the input light wavelength; the result is an amplified input signal.

Raman scattering is also utilised in optical converters utilised in optical communications systems for converting light of one wavelength to another wavelength. Certain optical applications require specific light wavelengths, for instance, Raman amplifiers, whether distributed or not, or high power Erbium doped fibre amplifiers (EDFAs). These specific light wavelengths do not always marry up with the wavelengths produced by readily available light sources, such as semiconductor laser devices. For example, there are readily available semiconductor laser devices which produce light at 915 nm and 980 nm, but these are not altogether useful wavelengths, particularly for amplifier pumping applications. An alternative option is to take the readily available devices and to convert the light they produce. A Raman converter is one way of achieving this. A converter module typically comprises a semiconductor laser device inputting light of one wavelength into an optical fibre. Within the fibre, the light undergoes Raman scattering and its wavelength is shifted. The conversion may require several shifts which may be achieved by “bouncing” light back and forth along the fibre; near each end of the fibre are fibre diffraction gratings which define a number of overlaid cavities and, within the cavities, the input and shifted wavelengths of light are contained. The gratings are so arranged that the “converted” wavelength of light is output from the fibre.

The number of gratings required in a Raman converter is dependent upon the Stokes shift of the fibre material, which dictates how many shifted wavelengths may be present. For example, a germanium silicate fibre exhibits a Stokes shift of 420 cm⁻¹. In order to achieve a conversion from 1060 to 1480 nm, thirteen gratings are necessary. This means that the converter may be inefficient, and up to 80% of the input light may be lost. Moreover, construction costs are proportional to component members and specifically the number of gratings. Phosphate fibres are better in these respects, exhibiting a Stoke shift of 1330 cm⁻¹, so that a 1060 nm to 1480 nm conversion requires only five gratings.

It is known to create optical fibre gratings, such as Bragg gratings, by illuminating a fibre with, say, UV light. Using a mask, a interference pattern may be projected at the fibre core. In the regions of high light intensity, the UV light breaks bond in the material of the fibre, changing its refractive index and forming a grating. Treating the fibre with hydrogen may increase sensitivity to UV light so as to tweak the refractive index. However, presence of hydrogen may result in high losses and, instead, the fibre may be treated with deuterium.

### OBJECT OF THE INVENTION

An object of the invention is to improve the efficiency of optical converters.

Another object of the invention is to provide an optical converter with a minimum number of components.

### BRIEF DESCRIPTION OF THE INVENTION

According to a first aspect, the invention provides an optical converter comprising a light source producing light of one wavelength, an optical fibre in which light from the source is converted by Raman scattering from the one wavelength to another wavelength, which light of another wavelength is output from the fibre, wherein the fibre is doped with deuterium.

The Stokes shift of deuterium doped fibre is such, that is large, that the conversion from one wavelength of light to another can be achieved with the minimum number of wavelength shifts, preferably one, so that losses are minimised as are the number of components necessary to make the required shift or number of shifts.

Preferably, the fibre core material is doped with deuterium and, further preferably, the fibre core material is germanium/silica. A deuterium doped germanium/silica core exhibits a Stoke's shift of 2660 cm⁻¹. Other core materials are, however, applicable according to requirements.

The fibre may typically be 0.5-1.5 km long

According to a second aspect, the invention provides an optical converter comprising a light source producing light of one wavelength, an optical fibre in which light from the source is converted by Raman scattering from the one wavelength to another wavelength, which light of another wavelength is output from the fibre, wherein the optical fibre is doped with a dopant such that the Stokes shift of the doped fibre equates to the conversion in one shift from the one wavelength to the another wavelength.

According to a third aspect, the invention provides an optical converter comprising a light source producing light of one wavelength, an optical fibre in which light from the source is converted by Raman scattering from the one wavelength to another wavelength, which light of another wavelength is output from the fibre, and an arrangement of wavelength specific devices defining only one cavity within the fibre.

The wavelength specific device may be a Bragg diffraction grating or similar or equivalent device.

Optical converters according to the invention are particularly useful for Raman fibre amplifiers, whether distributed or not, and other forms of fibre amplifiers such as high power EDFA amplifiers.

According to a fourth aspect, the invention provides the use of deuterium as a dopant for an optical fibre in an optical converter utilising Raman scattering.

According to a fifth aspect, the invention provides the use of a dopant for an optical fibre in an optical converter utilising Raman scattering, which optical converter converts light of one wavelength to another wavelength wherein the dopant is such that the Stokes shift of the doped fibre equates to the conversion in one shift from the one wavelength to the another wavelength.

According to a sixth aspect, the invention provides a method of converting light of one wavelength to another wavelength comprising subjecting the light of one wavelength to Raman scattering in an optical fibre doped with deuterium.

According to a seventh aspect, the invention provides a method of converting light of one wavelength to another wavelength comprising transporting the light of one wavelength along an optical fibre which includes a cavity defined by an arrangement of wavelength specific devices, in which cavity the light of one wavelength is subjected to Raman scattering, wherein the conversion of the light from one wavelength to another wavelength occurs in one shift.

According to a eighth aspect, the invention provides an optical source comprising an optical converter according to the first, second or third aspects of the invention.

According to a ninth aspect, the invention provides an optical module comprising an optical converter according to the first, second or third aspects of the invention.

According to a tenth aspect, the invention provides a fibre amplifier comprising an optical converter according to the first, second or third aspects of the invention.

According to a eleventh aspect, the invention provides an optical communications system comprising an optical converter according to the first, second or third aspects of the invention.

According to a twelfth aspect, the invention provides a method of making a doped optical fibre for use in an optical module comprising immersing the fibre in deuterium and irradiating the immersed fibre.

The fibre may be irradiated with UV or gamma radiation.

### BRIEF DESCRIPTION OF THE DRAWINGS

FIG. 1 is a schematic diagram of an optical converter according to the invention;

FIG. 2 is a schematic diagram showing the method of production of an optical fibre for use in the module shown in FIG. 1; and

FIG. 3 is a schematic diagram of an EDFA as an example of an optical module from an optical communications system utilising optical converters as shown in FIG. 1.

### DESCRIPTION OF THE INVENTION

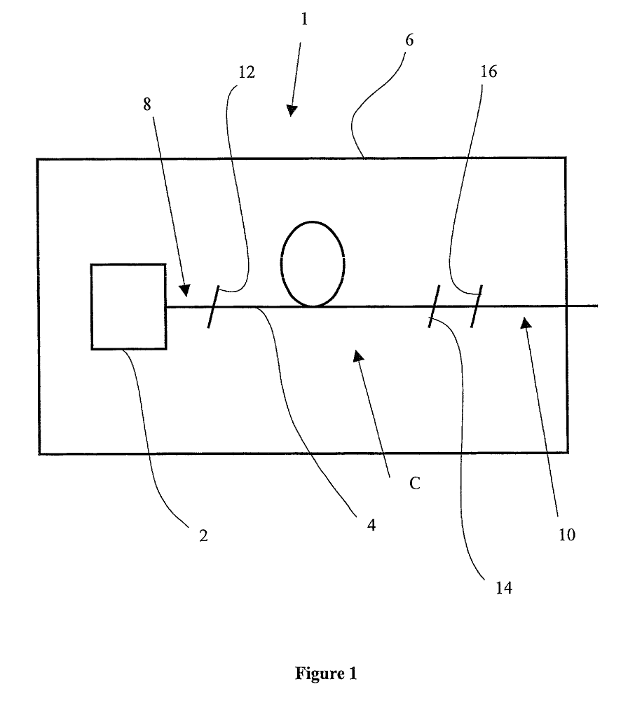

With reference to FIG. 1, an optical converter indicated generally at 1 has a semiconductor laser device 2 and associated drive and control circuitry (not shown), and a 1 km length of optical fibre 4, both housed in a casing 6. Light of wavelength 1060 nm from the device 2 is coupled into the input end 8 of the fibre 4. The output end 10 of the fibre 4 protrudes through the casing 6 for coupling to another device (not shown). The fibre 4 is provided with two Bragg fibre gratings 12, 14, in spaced apart relationship, each close a respective one of the ends 8, 10 of the fibre 4, so as to define a single fibre cavity C. A further Bragg fibre grating 16 is provided to the output side of the cavity C.

The fibre 4 has a germanium/silica core which is doped with deuterium giving the doped fibre 4 a long Stokes shift of 2660 cm⁻¹. In use of the converter 1, light at a wavelength of 1060 nm is input from the device 2 into the fibre 4 and enters cavity C where it undergoes Raman scattering. As a consequence of the long Stokes shift of the fibre 4, the input light is converted in one shift to a wavelength of 1480 nm. Only three gratings 12, 14, 16 are necessary because there is no need to bounce the light back and forth repeatedly until the required output wavelength is obtained. The Bragg fibre gratings are so arranged, with the gratings 12 and 14 reflecting light of 1480 nm and the grating 16 reflecting light of 1060 nm, that the converted light of 1480 nm is output from the output end 10 of the fibre 4.

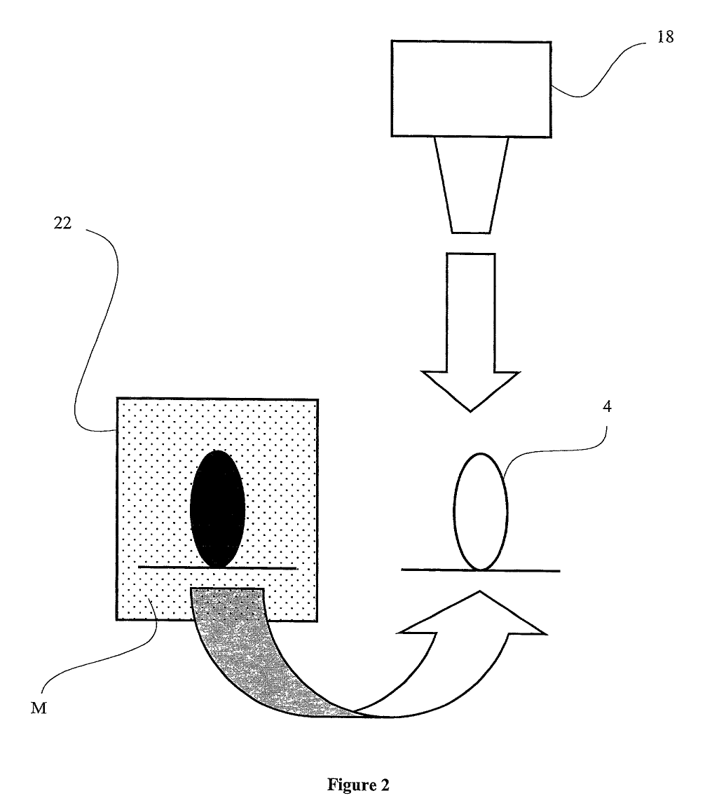

With further reference to FIG. 2, the doping is achieved by immersing a 1 km length of fibre 4 in a tank 22 of molecular deuterium M so as to saturate it. The deuterium-loaded fibre 4 is then removed and the gratings 12, 14 and 16 are written into the core in a conventional manner. The fibre 4 is next irradiated along its whole length with UV light from a source 18 so as to form bonds between the deuterium and the oxygen from the silica dioxide present in the fibre. This writes the deuterium into the fibre. The UV exposure time is determined by experimentation.

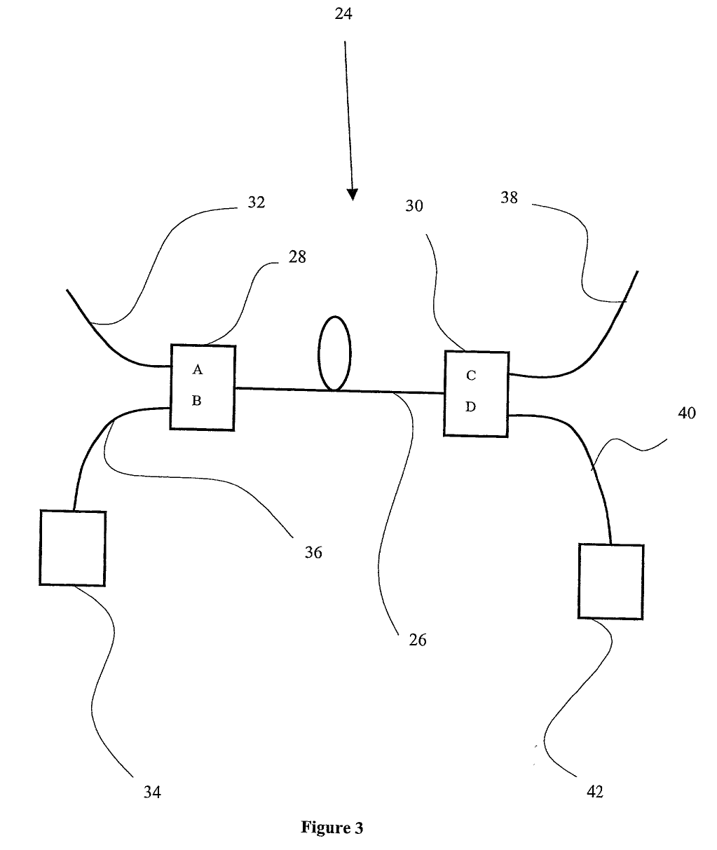

With reference to FIG. 3, an optical module, indicated generally at 24, an EDFA, has an active fibre section 26 extending between an input coupler 28 and an output coupler 30. The input coupler 28 has two inputs A, B, one A from an input transmission optical fibre 32 carrying an optical signal for amplification and the other, B, from an output optical fibre 36 from a co-pump light source 34. The output coupler 30 has two outputs C, D, one, C, to an output transmission fibre 38 carrying an amplified optical signal the other, D, from the output optical fibre 40 of a counter-pump light source 42. Each of the light sources 34, 36 comprises an optical converter of the form shown in FIG. 1, with a semiconductor laser device producing light of one wavelength converted to the appropriate wavelength for pumping the EDFA 24 by means of Raman scattering within an optical fibre. The EDFA 24 operates in a known manner with the pump light from the sources 34, 36 exciting dopant atoms in active fibre section 26, whose return to a lower energy level result in the emission of photons which supplement the optical signal. Such EDFAs are commonly used in optical communications systems.

1. An optical converter comprising a light source producing light of one wavelength, an optical fibre in which light from the source is converted by Raman scattering from the one wavelength to another wavelength, which light of another wavelength is output from the fibre, wherein the fibre is doped with deuterium.

2. An optical converter according to claim 1 wherein the fibre core is doped with deuterium.

3. An optical converter according to claim 2 wherein the fibre core is germanium/silica.

4. An optical converter comprising a light source producing light of one wavelength, an optical fibre in which light from the source is converted by Raman scattering from the one wavelength to another wavelength, which light of another wavelength is output from the fibre, wherein the optical fibre is doped with a dopant such that the Stokes shift of the doped fibre equates to the conversion in one shift from the one wavelength to the another wavelength.

5. An optical converter comprising a light source producing light of one wavelength, an optical fibre in which light from the source is converted by Raman scattering from the one wavelength to another wavelength, which light of another wavelength is output from the fibre, and an arrangement of wavelength specific devices defining only one cavity within the fibre.

6. An optical converter according to claim 5 wherein the wavelength specific device is a Bragg diffraction grating.

7. The use of deuterium as a dopant for an optical fibre in an optical converter utilising Raman scattering.

8. The use of a dopant for an optical fibre in an optical converter utilising Raman scattering, which optical converter converts light of one wavelength to another wavelength wherein the dopant is such that the Stokes shift of the doped fibre equates to the conversion in one shift from the one wavelength to the another wavelength.

9. A method of converting light of one wavelength to another wavelength comprising subjecting the light of one wavelength to Raman scattering in an optical fibre doped with deuterium.

10. A method of converting light of one wavelength to another wavelength comprising transporting the light of one wavelength along an optical fibre which includes a cavity defined by an arrangement of wavelength specific devices, in which cavity the light of one wavelength is subjected to Raman scattering, wherein the conversion of the light from one wavelength to another wavelength occurs in one shift.

11. An optical source comprising an optical converter according to claim 1.

12. An optical source comprising an optical converter according to claim 4.

13. An optical source comprising an optical converter according to claim 5.

14. An optical module comprising an optical converter according to claim 3.

15. An optical module comprising an optical converter according to claim 4.

16. An optical module comprising an optical converter according to claim 5.

17. An optical fibre amplifier comprising an optical converter according to claim 3.

18. An optical fibre amplifier comprising an optical converter according to claim 4.

19. An optical fibre amplifier comprising an optical converter according to claim 5.

20. An optical communications system comprising an optical converter according to claim 3.

21. An optical communications system comprising an optical converter according to claim 4.

22. An optical communications system comprising an optical converter according to claim 5.

23. A method of making a doped optical fibre for use in an optical module comprising immersing the fibre in deuterium and irradiating the immersed fibre.

24. A method according to claim 23 wherein the fibre is irradiated with UV or gamma radiation.
